(19) United States
(12) Patent Application Publication
(10) Pub. No.: US 2009/0027484 A1
(43) Pub. Date: Jan. 29, 2009

(54) Call Resource Management Based on Calling-Party Disengagement from a Call

(75) Inventors: George William Erhart, Loveland, CO (US); Valentine C. Matula, Granville, OH (US); David Joseph Skiba, Golden, CO (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/828,578

(22) Filed: Jul. 26, 2007

(51) Int. Cl. H04M 3/22

(52) U.S. Cl. 348/14.11; 379/190; 348/E05.001

(57) ABSTRACT

A system is disclosed that addresses a problem that can occur when a calling party of a video call withdraws from the call, but does not actually hang up. For example, after the calling party begins working through an interactive voice and video response (IVVR) session, the party might put his phone down, step away, drop the phone inadvertently, or otherwise disengage from the call without hanging up. In this event, the terminal itself is still connected to the call, so the call resource is tied up serving the terminal, even though the calling party has temporarily disengaged from the call. The system of the illustrative embodiment detects the disengagement of the party from the call and, as a result, suspends the use of the call resource that has been allocated for the call until the party re-engages with the call.

### FIELD OF THE INVENTION

The present invention relates to telecommunications in general, and, more particularly, to managing a call-related resource, based on whether a calling party has disengaged from a call.

### BACKGROUND OF THE INVENTION

A call center is a centralized office used for the purpose of handling a large volume of telephone calls. For example, a call center can be operated by an enterprise to process incoming calls from customers seeking product support or other information, in which the calls are directed to service agents who can then assist the customers. An enterprise can use a call center for outgoing calls as well.

FIG. 1 depicts telecommunications system 100 in the prior art, which features a call center. Telecommunications system 100 comprises telecommunications terminals 101-1 through 101-M, wherein M is a positive integer; telecommunications network 105; private branch exchange (PBX) 110; telecommunications terminals 111-1 through 111-N, wherein N is a positive integer; and interactive voice response (IVR) system 120, the depicted elements being interconnected as shown. The call center itself comprises elements 110, 111-1 through 111-N, and 120.

Calling telecommunications terminal 101-m, where m has a value between 1 and M, is one of a telephone, a notebook computer, a personal digital assistant (PDA), etc. and is capable of placing and receiving calls via telecommunications network 105.

Telecommunications network 105 is a network such as the Public Switched Telephone Network [PSTN], the Internet, etc. that carries calls to and from telecommunications terminal 101, private branch exchange 110, and other devices not appearing in FIG. 1. A call might be a conventional voice telephony call, a video-based call, a text-based instant messaging (IM) session, a Voice over Internet Protocol (VoIP) call, and so forth.

Private branch exchange (PBX) 110 receives incoming calls from telecommunications network 105 and directs the calls to IVR system 120 or to one of a plurality of telecommunications terminals within the enterprise (i.e., enterprise terminals 111-1 through 111-N), depending on how exchange 110 is programmed or configured. For example, in an enterprise call center, exchange 110 might comprise logic for routing calls to service agents' terminals based on criteria such as how busy various service agents have been in a recent time interval, the telephone number called, and so forth.

Additionally, exchange 110 might be programmed or configured so that an incoming call is initially routed to IVR system 120, and, based on caller input to system 120, subsequently redirected back to exchange 110 for routing to an appropriate telecommunications terminal within the enterprise. Possibly, exchange 110 might queue each incoming call if all agents are busy, until the queued call can be routed to an available agent at one of enterprise terminals 111-1 through 111-N. Exchange 110 also receives outbound signals from enterprise terminals 111-1 through 111-N and from IVR system 120, and transmits the signals on to telecommunications network 105 for delivery to a caller's terminal.

Enterprise telecommunications terminal 111-n, where n has a value between 1 and N, is typically a deskset telephone, but can be a notebook computer, a personal digital assistant (PDA), and so forth, and is capable of receiving and placing calls via telecommunications network 105.

Interactive voice response (IVR) system 120 is a data-processing system that presents one or more menus to a caller and receives caller input (e.g., speech signals, keypad input, etc.), as described above, via private branch exchange 110. Many business enterprises employ an IVR system such as system 120. An interactive voice response system typically presents a hierarchy of menus to the caller, and prompts the caller for input to navigate the menus and to supply information to the IVR system. For example, a caller might touch the “3” key of his terminal's keypad, or say the word “three”, to choose the third option in a menu. Similarly, a caller might specify his bank account number to the interactive voice response system by inputting the digits via the keypad, or by saying the digits. In many interactive voice response systems, the caller can connect to a person in the enterprise by either selecting an appropriate menu option or by entering the telephone extension associated with that person.

IVR system 120 is typically programmable and performs its tasks by executing one or more instances of an IVR system application. An IVR system application typically comprises one or more scripts that specify what speech is generated by IVR system 120, what input to collect from the caller, and what actions to take in response to caller input. For example, an IVR system application might comprise a top-level script that presents a main menu to the caller, and additional scripts that correspond to each of the menu options (e.g., a script for reviewing bank account balances, a script for making a transfer of funds between accounts, etc.).

A data-processing system such as IVR system 120 or PBX 110 constantly allocates call-related resources to a call, such as assigning an instance of an IVR application or queuing a call until an agent is available, and allocates resources even before the call is directed to a service agent. When resources are already allocated to calls, there are fewer resources to allocate to future calls, especially if it takes a while to eventually route each call to an agent or to other final call treatment.

### SUMMARY OF THE INVENTION

The present invention addresses a problem that can occur when a calling party of a video call withdraws from the call, but does not actually hang up. For example, after the calling party begins working through an interactive voice and video response (IVVR) session, the party might put his phone down, step away, drop the phone inadvertently, or otherwise disengage from the call without hanging up. In this event, the terminal itself is still connected to the call, so the call resource is tied up serving the terminal, even though the calling party has temporarily disengaged from the call. The system of the illustrative embodiment detects the disengagement of the party from the call and, as a result, suspends the use of the call resource that has been allocated for the call until the party re-engages with the call.

The system is able to detect the disengagement of the calling party from the video call by monitoring the video signal. When it is determined that the calling party is no longer present, the system transmits a signal to suspend the further use of the resource for a call while the party is disengaged. For example, if the call was in a state that involved an IVVR application, the system suspends the further use of the application by the call until the calling party returns. As another example, if the call was already queued and awaiting an agent to service the call, the system might freeze the call's position in the queue until the calling party returns to the phone and re-engages with the call. In some alternative embodiments, the system allows the call to work its way to the top of the queue, even with the calling party having disengaged, and then freezes the call's position at the top of the queue.

The system of the illustrative embodiment is advantageous, in that it manages limited call resources while the calling parties are disengaged. Additionally, the system avoids prematurely disconnecting a calling party who is temporarily away from her terminal. By managing the call resources, the system can improve the number of calls per hour that can be handled, or the system can be used to optimize the initial provisioning of call resources for a given level of anticipated call traffic, or both.

The illustrative embodiment of the present invention comprises: allocating a resource to a call that involves a calling party and a calling-party terminal; detecting that the calling party, but not the calling-party terminal, has disengaged from the call; suspending the usage of the resource by the call until the calling party re-engages with the call via the calling-party terminal; and when the calling party has re-engaged with the call, transmitting a signal to re-enable the usage of the resource by the call

### BRIEF DESCRIPTION OF THE DRAWINGS

FIG. 1 depicts telecommunications system 100 in the prior art.

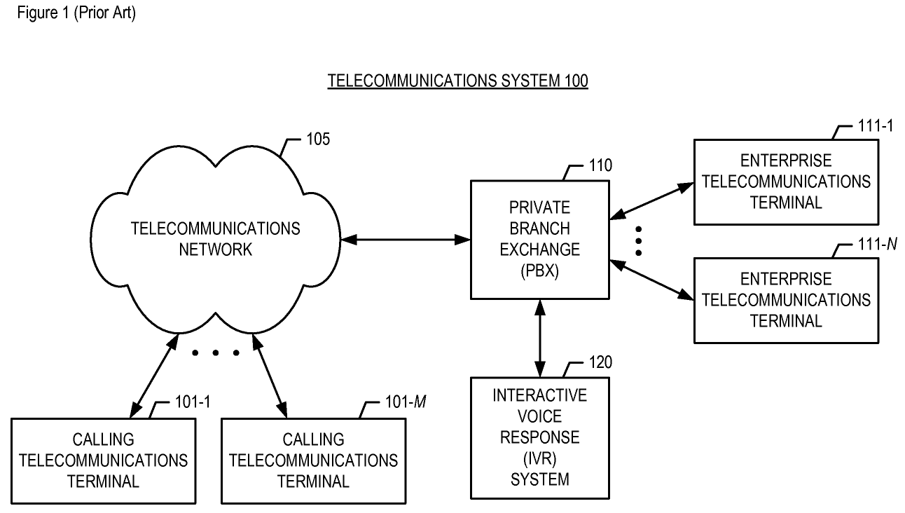

FIG. 2 depicts telecommunications system 200, in accordance with the illustrative embodiment of the present invention.

FIG. 3 depicts a flowchart of the salient tasks of interactive voice and video response (IVVR) system 220 in telecommunications system 200.

### DETAILED DESCRIPTION

The following terms are defined for use in this Specification, including the appended claims:
The term “call,” and its inflected forms, is defined as an interactive communication involving one or more telecommunications terminal (e.g., “phone”, etc.) users, who are also known as “parties” to the call. A video call is featured in the illustrative embodiment of the present invention, in which the image of at least one of the call parties is transmitted to another call party. As those who are skilled in the art will appreciate, in some alternative embodiments, a call might be a traditional voice telephone call, an instant messaging (IM) session, and so forth. Furthermore, a call can involve one or more human call parties or one or more automated devices, alone or in combination with each other.
The term “call disengagement,” and its inflected forms, is defined as the withdrawal of a call party from a call. For example, a call party who is on hold might step away from her phone, put the phone down, or drop the phone, but not hang up. When a party disengages from the call, the party's phone can still be connected to the call, and as a result, the call party can later re-engage with the call via her phone.
The term “image,” and its reflected forms, is defined as a reproduction of the likeness of some subject, such as a person or object. An image can be that of a still subject or moving subject, and the image itself can be fixed or changing over time. When it is received or transmitted, such as in a computer file or in a video stream, the image is represented by a signal. The creation of the signal can involve analog signal processing, as is the case with standard television or other analog video systems, or digital signal processing, as is the case with high-definition television or other video systems that feature digital compression of images.

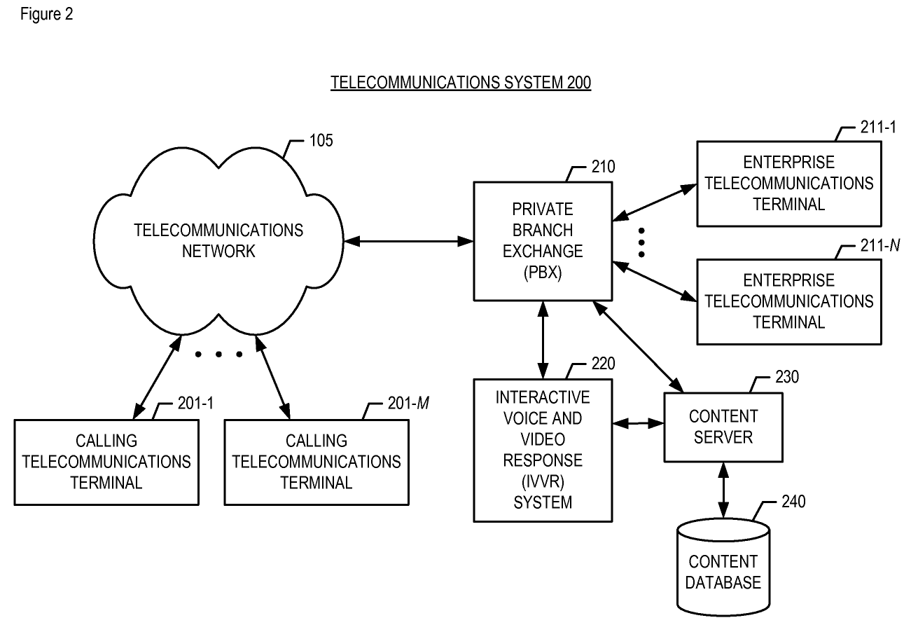

FIG. 2 depicts telecommunications system 200, which features a call center, in accordance with the illustrative embodiment of the present invention. Telecommunications system 200 comprises calling telecommunications terminals 201-1 through 201-M, wherein M is a positive integer; telecommunications network 105; private branch exchange (PBX) 210; enterprise telecommunications terminals 211-1 through 211-N, wherein N is a positive integer; interactive voice and video response system 220; content server 230; and content database 240, the depicted elements being interconnected as shown. The call center itself comprises elements 210, 211-1 through 211-N, 220, 230, and 240.

Calling telecommunications terminal 201-m, where m has a value between 1 and M, is a device that is capable of originating or receiving calls, or both. For example, terminal 201-m can be one of a telephone, a notebook computer, a personal digital assistant (PDA), and so forth. Terminals 201-1 through 201-M can be different from one another, such that terminal 201-1 can be a desk set, terminal 201-2 can be a cell phone, terminal 201-3 can be a softphone on a notebook computer, and so forth.

Terminal 201-m handles calls via telecommunications network 105 and is capable of exchanging video, voice, and call processing-related signals with one or more other devices, such as terminal 211-n through private branch exchange 210. To this end, terminal 201-m exchanges one or more of Internet Protocol (IP) data packets, Session Initiation Protocol (SIP) messages, Voice over IP (VoIP) traffic, and stream-related messages (e.g., Real Time Streaming Protocol [RTSP] messages, etc.) with private branch exchange 210.

In order to handle video signals with its user, terminal 201-m comprises a video camera and display, in addition to comprising other interfaces with its user such as a microphone, speaker, and keypad or keyboard. It will be clear to those skilled in the art how to make and use terminal 201-m.

Private branch exchange (PBX) 210 is a data-processing system that provides all of the functionality of private branch exchange 110 of the prior art. In addition to handling conventional telephony-based signals, exchange 210 is also capable of exchanging Internet Protocol (IP) data packets, Session Initiation Protocol (SIP) messages, Voice over IP (VoIP) traffic, and stream-related messages (e.g., Real Time Streaming Protocol [RTSP] messages, etc.) with terminals 201-1 through 201-M and terminals 211-1 through 211-N.

Exchange 210 is further capable of communicating with interactive voice and video response system 220. Exchange 210 and system 220 can coordinate media signal transmissions on a call-by-call basis, or exchange 210 can feed system 220 the media signals from some or all of the calling parties. In accordance with the illustrative embodiment, for a given call, exchange 210 transmits to system 220 the media signals of the calling party of terminal 201-m. Exchange 210 also receives signals from system 220, such as voice and video responses, and forwards those signals to terminal 201-m, the terminal of the calling party.

In some embodiments, exchange 210 is also capable of receiving streamed content (e.g., news clips, movie trailers, filler advertisements, music videos, audiocasts, user instructions, etc.) of one or more media types (e.g., video, audio, multimedia, etc.) from content server 230, of forwarding streamed content on to telecommunications network 105 for delivery to a caller's terminal, and of transmitting signals related to streamed content to content server 230. It will be clear to those skilled in the art, after reading this specification, how to make and use exchange 210.

Enterprise telecommunications terminal 211-n, where n has a value between 1 and N, is a device that is capable of originating or receiving calls, or both. In accordance with the illustrative embodiment, terminal 211-n is a workstation softphone at a call center; in some alternative embodiments, however, terminal 211-n can be one of a telephone, a notebook computer, a personal digital assistant (PDA), and so forth. As those who are skilled in the art will appreciated, terminals 211-1 through 211-N can be different from one another.

Terminal 211-n handles calls via exchange 210 and is capable of exchanging video, voice, and call processing-related signals with one or more other devices, such as terminal 201-m through network 105. To this end, terminal 211-n exchanges one or more of Internet Protocol (IP) data packets, Session Initiation Protocol (SIP) messages, Voice over IP (VoIP) traffic, and stream-related messages (e.g., Real Time Streaming Protocol [RTSP] messages, etc.) with private branch exchange 210.

In order to handle video signals with its user, terminal 211-n comprises a video camera and display, in addition to comprising other interfaces with its user such as a microphone, speaker, and keypad or keyboard. It will be clear to those skilled in the art how to make and use terminal 211-n.

Interactive voice and video response (IVVR) system 220 is a data-processing system that provides all the functionality of interactive voice response system 120 of the prior art. In addition, system 220 is capable of transmitting commands to content server 230 (e.g., starting playback of a media stream, stopping playback of a media stream, queuing another media stream, etc.), of receiving information from content server 230 (e.g., an indication that playback of a media stream has begun, an indication that playback of a media stream has completed, etc.), and of receiving status information regarding the delivery of media streams to terminal 201-m.

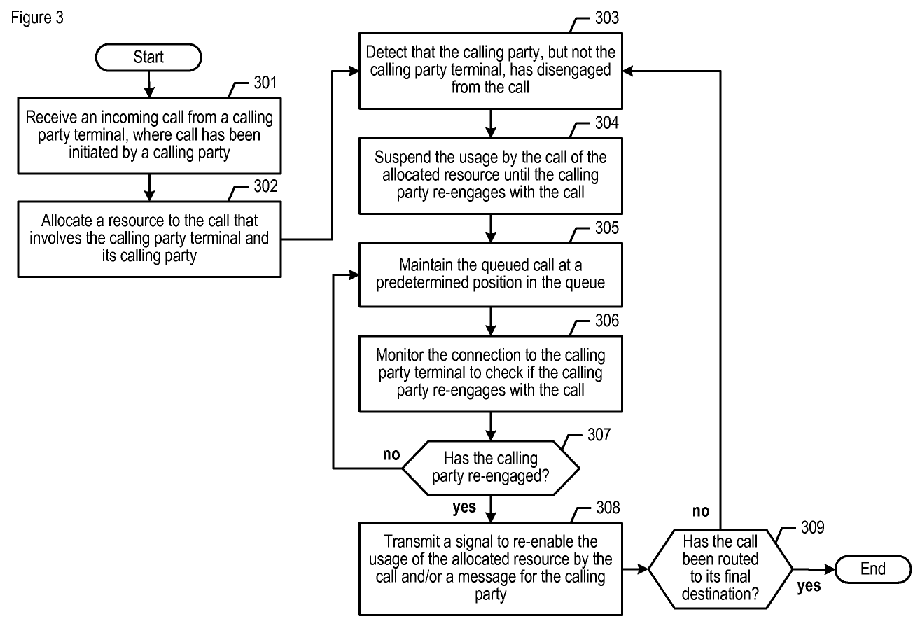

System 220 is further capable of performing the tasks of FIG. 3, described below. In performing those tasks for a given call, system 220 receives media signals of a calling party from exchange 210 and provides signals back to exchange 210, possibly to update the calling party at terminal 201-m. It will be clear to those skilled in the art, after reading this specification, how to make and use system 220.

Content server 230 is a data-processing system that is capable of retrieving content from content database 240, of buffering and delivering a media stream to a calling terminal via exchange 210, of receiving commands from system 220 (e.g., to start playback of a media stream, to queue another media stream, etc.), of transmitting status information to system 220, and of generating content (e.g., dynamically generating a video of rendered text, summarizing or abbreviating the content of a media stream, etc.) in well-known fashion. It will be clear to those skilled in the art, after reading this specification, how to make and use content server 230.

Content database 240 is capable of storing a plurality of multimedia content (e.g., video content, audio content, etc.) and of retrieving content in response to commands from content server 230, in well-known fashion. In some embodiments, database 240 stores a summarized or abbreviated version of at least some of the multimedia content already being stored. It will be clear to those skilled in the art, after reading this specification, how to make and use content database 240.

As will be appreciated by those skilled in the art, some embodiments of the present invention might employ an architecture for telecommunications system 200 that is different than that of the illustrative embodiment. For example, in some embodiments, interactive voice response system 220 and content server 230 might reside on a common server. In some other embodiments, content server 230 and content database 240 might not even be present. It will be clear to those skilled in the art, after reading this specification, how to make and use such alternative architectures.

FIG. 3 depicts a flowchart of the salient tasks of interactive voice and video response (IVVR) system 220, in accordance with the illustrative embodiment of the present invention. As those who are skilled in the art will appreciate, at least some of the tasks depicted in FIG. 3 can be performed simultaneously or in a different order than that depicted. In accordance with the illustrative embodiment, IVVR system 220 executes the depicted tasks, which are described below. However, it will be clear to those skilled in the art, after reading this specification, how to make and use alternative embodiments of the present invention, in which a data-processing system other than system 220, such as PBX 210, executes some or all of the described tasks.

For pedagogical purposes, system 220—as well as exchange 210, server 230, and database 240—support a call center, at which human service agents who are stationed at terminals 211-1 through 211-N interact with calling parties who use terminals 201-1 through 201-M to make video calls. However, it will be clear to those skilled in the art, after reading this specification, how to make and use alternative embodiments of the present invention, in which some or all of telecommunications system 200 is used to support communication other than that associated with a call center's operations or to support communication other than video calls, or both. Although an example for a single call is described, it will be clear to those skilled in the art how to concurrently process multiple calls by using the described tasks on each call.

During the processing of a video call in the illustrative embodiment, as a first possibility, a calling party might be immediately connected to a human agent at terminal 211-n. As a second possibility, the calling party might be served first by IVVR system 220 and then directed to a human agent. As a third possibility, the calling party might be served first by system 220, then queued by either PBX 210 or system 220 if all human agents are busy, then directed to a human agent when one is available. As those who are skilled in the art will appreciate, the calling party might be handled in other ways than those already stated. Furthermore, it might be another type of party to the call, such as a called party, whose actions are monitored and accounted for in the described tasks. In any event, at least some of the tasks described below concern the interval of time between when i) the calling party initiates the call and ii) the call is routed to its final destination (e.g., to an agent that has become available, etc.).

At task 301, IVVR system 220 receives an incoming call from a calling-party terminal, where the call has been initiated by a calling party (i.e., the user of the calling-party terminal). For example, the calling party might want to speak to a human agent, who happens to be stationed at one of terminals 211-1 through 211-N. For pedagogical purposes, terminal 201-1 is used as the calling-party terminal and terminal 201-1's user is the calling party. As those who are skilled in the art will appreciate, however, another terminal can be used as the calling-party terminal.

At task 302, system 220 allocates a resource to the call that involves calling-party terminal 201-1 and its calling party. The actual resource that is allocated depends on what is required to support the call. As a first example, the allocation of the resource might involve assigning an instance of an interactive voice and video response (IVVR) application to the call, if the calling party is to be first directed to an IVVR session. As a second example, if a human agent is presently unavailable to accept the call, where the call might or might not have already been handled by the IVVR application, the allocation of the resource might involve queuing the call until a human agent becomes available. As those who are skilled in the art will appreciate, there can be other examples of resource allocation that are relevant to the embodiments of the present invention.

At task 303, system 220 detects that the calling party, but not calling-party terminal 201-1, has disengaged from the call. In accordance with the illustrative embodiment, the detection of the disengagement comprises determining that a signal that contains an image of the calling party is no longer being received. To detect the disengagement, IVVR system 220 uses a “face identification” technique, which is well-known in the art, to determine that the calling party's face, which had been previously detected, is no longer present, the implication being that that the calling party has disengaged from the call.

As those who are skilled in the art will appreciate, other techniques can be used to detect the disengagement of the calling party, alone or in combination with the technique described above or with each other. For example, if the calling party has “video muted” the call, as is known in the art, system 220 can detect that the video signal of the call has been lost, if only temporarily. Furthermore, although system 220 detects the disengagement of the calling party from the call, in some alternative embodiments terminal 201-1, or some other device, detects the disengagement and then informs system 220 about the disengagement.

At the same time, system 220 is still in communication with terminal 201-1, which has not transmitted a disconnect message and is, therefore, determined by system 220 to be still on the call.

At task 304, system 220 suspends the usage by the call of the allocated resource until the calling party re-engages with the call via terminal 201-1. For example, if an instance of an IVVR application has been assigned, system 220 suspends the usage of the IVVR application by the call. As another example, if the call has been queued, system 220 maintains the queued call at a predetermined position in the queue, as described at task 305 below.

At task 305, if the call has been queued, system 220 maintains the queued call at a predetermined position in the queue. The position in the queue can be the present position (i.e., a position related to when the detection occurs that the calling party has disengaged), the position at the top of the queue, or at yet another position. If the position at which the call is to be maintained has not yet been reached, system 220 continues to move the call up the queue in well-known fashion as other calls are removed from the queue and routed to available agents. When the predetermined position in the queue is reached, system 220 holds the call at that queue position.

At task 306, system 220 monitors the connection to terminal 201-1 to check if the calling party re-engages with the call.

At task 307, if the calling party has re-engaged, system 220 proceeds to task 308. If the calling party has not re-engaged, task execution proceeds back to task 305.

At task 308, system 220 transmits a signal to re-enable the usage of the allocated resource by the call. For example, system 220 might need to notify content server 230 of the change in the calling party status.

In some embodiments, system 220 transmits a message for the calling party, wherein the content of the message is relevant to the calling party having re-engaged. For example, the message might comprise the IVVR-related message played prior to the detection of the calling party having disengaged or might inform the calling party of her call's current position in the queue. The message might be coupled with audio or video content retrieved from content database 240 by content server 230, or the message might be transmitted by itself. System 220 might transmit the calling-party relevant message either in addition to or instead of the re-enabling signal.

At task 309, system 220 checks if the video call has been routed to its final destination (e.g., to terminal 211-n, etc.). If so, task execution ends. If not, task execution proceeds back to task 303, in order to process any additional disengagements from the call.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
allocating a resource to a call that involves a calling party and a calling-party terminal;
detecting that the calling party, but not the calling-party terminal, has disengaged from the call;
suspending the usage of the resource by the call until the calling party re-engages with the call via the calling-party terminal; and
when the calling party has re-engaged with the call, transmitting a signal to re-enable the usage of the resource by the call.

2. The method of claim 1 wherein the allocation of the resource comprises queuing the call.

3. The method of claim 2 wherein the suspension comprises maintaining a position of the call in a queue.

4. The method of claim 3 wherein the suspension occurs only after the call has reached the top of the queue, at which point the position of the call at the top of the queue is maintained.

5. The method of claim 3 wherein the position of the call in the queue is the position at which the detection occurs that the calling party has disengaged.

6. The method of claim 1 wherein the allocation of the resource comprises assigning an instance of an interactive voice response application to the call.

7. The method of claim 1 wherein the call is a video call, and wherein the detection of the disengagement comprises determining that a signal that contains an image of the calling party is no longer being received.

8. A method comprising:
allocating a resource to a video call that involves a calling party and a calling-party terminal;
detecting that the calling party, but not the calling-party terminal, has disengaged from the video call, wherein the detection is based on determining that a signal that contains an image of the calling party is no longer being received;
suspending the usage of the resource by the call until the calling party re-engages with the video call via the calling-party terminal;
when the calling party has re-engaged with the call, transmitting a signal to re-enable the usage of the resource by the call.

9. The method of claim 8 wherein the allocation of the resource comprises queuing the call.

10. The method of claim 9 wherein the suspension comprises maintaining a position of the call in a queue.

11. The method of claim 10 wherein the suspension occurs only after the call has reached the top of the queue, at which point the position of the call at the top of the queue is maintained.

12. The method of claim 10 wherein the position of the call in the queue is the position at which the detection occurs that the calling party has disengaged.

13. The method of claim 8 wherein the allocation of the resource comprises assigning an instance of an interactive voice response application to the call.

14. A method comprising:
queuing a video call in a queue, the video call involving a calling party and a calling-party terminal;
detecting that the calling party, but not the calling-party terminal, has disengaged from the video call;
maintaining a predetermined position of the video call in the queue until the calling party re-engages with the call via the calling-party terminal; and
when the calling party has re-engaged with the call, transmitting to the calling-party terminal a message for the calling party, wherein the content of the message is relevant to the calling party having re-engaged.

15. The method of claim 14 wherein the maintaining of the predetermined position in the queue occurs only after the video call has reached the top of the queue.

16. The method of claim 14 wherein the position of the call in the queue is based on the position at which the detection occurs that the calling party has disengaged.

17. The method of claim 14 wherein the detection of the disengagement comprises determining that a signal that contains an image of the calling party is no longer being received.

18. A method comprising:
assigning an instance of an interactive voice response application to a call that involves a calling party and a calling-party terminal;
detecting that the calling party, but not the calling-party terminal, has disengaged from the call;
suspending the usage of the interactive voice response application by the call until the calling party re-engages with the call via the calling-party terminal; and
when the calling party has re-engaged with the call, transmitting to the calling-party terminal a message for the calling party, wherein the content of the message is relevant to the calling party having re-engaged.

19. The method of claim 18 wherein the call is a video call.

20. The method of claim 19 wherein the detection of the disengagement comprises determining that a signal that contains an image of the calling party is no longer being received.
